(19) United States
(12) Patent Application Publication
(10) Pub. No.: US 2021/0168347 A1
(43) Pub. Date: Jun. 3, 2021

(54) Cross-Modality Face Registration and Anti-Spoofing

(71) Applicant: CLAIRLABS LTD., Tel Aviv (IL)

(72) Inventors: Ran Margolin, Hod Hasharon (IL); Adi Berenson, Tel Aviv (IL)

(21) Appl. No.: 17/101,067

(22) Filed: Nov. 23, 2020

Related U.S. Application Data
(60) Provisional application No. 62/942,235, filed on Dec. 2, 2019.

(51) Int. Cl. H04N 13/239; H04N 5/247; H04N 5/33; G06K 9/62; G06K 9/00; G06N 3/08; G06F 17/18

(52) U.S. Cl. CPC H04N 13/239; H04N 5/247; H04N 5/33; G06K 9/6201; H04N 2013/0081; G06K 9/00899; G06N 3/08; G06F 17/18; G06K 9/00288

(57) ABSTRACT

A system includes a stereo camera, a memory and a processor. The camera includes a first imaging device configured to acquire a first image of an object at a first wavelength range from a first direction, and a second imaging device configured to acquire a second image of the object at a second wavelength range from a second direction. The memory is configured to store weights of an ANN trained to estimate a spatial disparity between a first image patch of the first image and a second image patch of the second image. The processor is configured to (a) apply the ANN to the first and second image patches so as to estimate (i) the spatial disparity and (ii) a degree of matching between the first and second image patches at the estimated spatial disparity, and (b) output the estimated degree of matching.

### CROSS-REFERENCE TO RELATED APPLICATIONS

This application claims the benefit of U.S. Provisional Patent Application 62/942,235, filed Dec. 2, 2019, whose disclosure is incorporated herein by reference.

### FIELD OF THE INVENTION

The present invention relates generally to image processing, and particularly to face recognition.

### BACKGROUND OF THE INVENTION

Stereo matching techniques including a use of infrared sensor were previously reported in the patent literature. For example, U.S. Pat. No. 7,961,906 describes a method and apparatus for determining human beings from terrain or man-made obstacles. A long-wave infrared (LWIR) camera along with additional devices such as a color camera or two cameras in stereo configuration, are used such that the physical scene captured in one image is the same from both the devices. The images may be processed such that areas of interest representing characteristics of human beings are labeled accordingly. The processing may include determining the physical size, range, and relative locations of the objects found in the images. In an embodiment, a processor generates a masked disparity map that includes the disparity map masked with the one or more areas of the image, and determines that the image includes a human being by determining that a surface area of the masked disparity map is consistent with a surface area of the human being.

### SUMMARY OF THE INVENTION

An embodiment of the present invention that is described hereinafter provides a system including a stereo vision camera, a memory and a processor. The stereo vision camera includes a first imaging device configured to acquire a first image of an object at a first wavelength range from a first direction, and a second imaging device configured to acquire a second image of the object at a second wavelength range from a second direction. The memory is configured to store weights of an artificial neural network (ANN) trained to estimate a spatial disparity between a first image patch of the first image and a second image patch of the second image. The processor is configured to (a) apply the trained ANN to the first and second image patches so as to estimate (i) the spatial disparity mapping between the first and second image patches, and (ii) a degree of matching between the first and second image patches according to the estimated spatial disparity mapping, and (b) output the estimated degree of matching.

In some embodiments, the object is a human face.

In some embodiments, the processor is configured to estimate the degree of matching between the first and second image patches by applying an anti-spoofing algorithm to the first and second image patches.

In an embodiment, one of the first wavelength range and the second wavelength range is long-wave infrared (LWIR), and the other of the first wavelength range and the second wavelength range is near infrared (NIR).

In another embodiment, the processor is configured to rectify the first and second images before estimating the spatial disparity.

In some embodiments, the processor is configured to derive the weights of the ANN by training another ANN, which includes the ANN, the other ANN including a Siamese twin sub-neural network.

In some embodiments, the processor is configured to estimate the spatial disparity by estimating, using the ANN, a probability distribution of the spatial disparity as a function of the spatial disparity between the first and second image patches, and finding the spatial disparity that maximizes the probability distribution.

In other embodiments, the processor is configured to estimate the degree of matching by normalizing the probability distribution and calculating a value of the normalized probability distribution at the found spatial disparity.

There is additionally provided, in accordance with another embodiment of the present invention, a system including a first imaging device, a second imaging device, a third imaging device, and a processor. The first imaging device is configured to acquire a first image of an object at a first wavelength range from a first direction. The second imaging device is configured to acquire a second image of the object at the first wavelength range from a second direction. The third imaging device is configured to acquire a third image of the object at the second wavelength range from a third direction. The processor is configured to (a) estimate a spatial disparity between a first image patch of the first image and a second image patch of the second image, (b) using the estimated spatial disparity, estimate a degree of matching between a third image patch of the third image and one of the first and second image patches, and (c) output the estimated degree of matching.

In some embodiments, the processor is configured to estimate the degree of matching between the third image patch and one of the first and second image patches by applying an anti-spoofing algorithm to the third image patch and one of the first and second image patches.

In some embodiments, the processor is configured to estimate the spatial disparity using a geometrical model.

In an embodiment, the third direction is one of the first direction and the second direction. In another embodiment, the third direction is an average of the first direction and the second direction.

In some embodiments, the first wavelength range is near infrared (NIR) and the second wavelength range is long-wave infrared (LWIR).

In some embodiments, the processor is configured to rectify the first, second and third images before estimating the disparity.

There is further provided, in accordance with another embodiment of the present invention, a method including acquiring a first image of an object at a first wavelength range from a first direction, and a second image of the object at a second wavelength range from a second direction. Weights are stored, of an artificial neural network (ANN) trained to estimate a spatial disparity between a first image patch of the first image and a second image patch of the second image. The trained ANN is applied to the first and second image patches so as to estimate (i) the spatial disparity between the first and second image patches, and (ii) a degree of matching between the first and second image patches at the estimated spatial disparity. The estimated degree of matching is outputted.

There is further yet provided, in accordance with yet another embodiment of the present invention a method, including acquiring a first image patch of an object at a first wavelength range from a first direction. A second image patch of the object is acquired at the first wavelength range from a second direction. A third image patch of the object is acquired at the second wavelength range from a third direction. A spatial disparity is estimated, between a first image patch of the first image and a second image patch of the second image. Using the estimated spatial disparity, a degree of matching is estimated, between a third image patch of the third image and one of the first and second image patches. The estimated degree of matching is outputted.

The present invention will be more fully understood from the following detailed description of the embodiments thereof, taken together with the drawings in which:

### BRIEF DESCRIPTION OF THE DRAWINGS

FIG. 1 is a schematic, pictorial block diagram of a dual-wavelength imaging system configured to perform image patch registration of an acquired face using a trained artificial neural network (ANN), in accordance with an embodiment of the present invention;

FIG. 2 is a diagram that schematically illustrates handling of a task of estimating a disparity of a given query patch as a classification problem that can be solved using the ANN of FIG. 1, in accordance with an embodiment of the present invention;

FIG. 3 is a schematic, pictorial block diagram of an ANN trained to perform anti-spoofing of facial image patches acquired using the dual-wavelength imaging system of FIG. 1, in accordance with an embodiment of the present invention;

FIG. 4 is a flow chart that schematically illustrates a method to perform anti-spoofing of facial image patches acquired using the ANN of the dual-wavelength imaging system of FIG. 1, in accordance with an embodiment of the present invention;

FIG. 5 is diagram showing an example of actual performance of the dual-wavelength imaging system FIG. 1 in differentiating between acquired faces, in accordance with an embodiment of the present invention; and

FIG. 6 is a schematic, pictorial block diagram of a dual-wavelength imaging system configured to perform anti-spoofing of an acquired facial image patch, in accordance with another embodiment of the present invention.

### DETAILED DESCRIPTION OF EMBODIMENTS

### Overview

Embodiments of the present invention that are described hereinafter provide techniques to perform registration of facial features between two distinct imaging modalities of a stereo vision system, such as between image patches acquired in two different wavelength ranges by two or more separate sensors in a stereo vision configuration. An example of two different wavelength ranges is long wavelength infrared (LWIR) and near-infrared (NIR). The disclosed registration is useful in stereo vision applications such as face recognition, sleep monitoring, and other monitoring applications. Example applications are described in U.S. Patent Application Publication 2019/0362133, which is assigned to the assignee of the present invention and whose disclosure is incorporated herein by reference. The disclosed techniques also provide anti-spoofing features that are particularly useful in ensuring that facial recognition algorithms are not fooled by malicious users.

In some embodiments, the stereo vision system comprises a stereo camera having two spatially displaced image sensors of different wavelength ranges. The system further comprises a processor that handles image acquisition, synchronization and registration. Subsequent processing steps for various monitoring applications may also be performed by the processor. In an embodiment, one image sensor of the stereo vision system operates in the near infrared (NIR) wavelength range of 760-1500 nm (such as a CMOS sensor, with peak sensitivity at wavelengths around 1 μm), and another operates at long-wave infrared (LWIR) wavelength range of 0.3-50 μm (such as a microbolometer array with sensitivity to wavelengths around 10 μm). The sensor arrays are built approximately co-planar inside the camera.

As used herein, the term “approximately” for any numerical value or range indicates a suitable dimensional tolerance that allows the part or collection of components to function for its intended purpose as described herein. More specifically, “approximately” may refer to the range of values ±10% of the recited value, e.g. “approximately 90%” may refer to the range of values from 81% to 99%.

In some embodiments, the processor performs the task of registration between the different wavelength image patches as a cross-imaging-modality passive-stereo problem. The registration is accomplished in three steps, as follows:

1. System calibration to synchronize and learn the intrinsic and extrinsic parameters of the different sensors.

2. Given the intrinsic and extrinsic parameters, rectifying images from both modalities, i.e. projecting both images onto a common plane learned in the calibration process.

3. Cross-modality face matching by inferring predefined facial feature probability distribution over all possible disparities, wherein the “disparity” is the displacement between a first wavelength image patch and a second wavelength image patch taken by the two respective imaging modalities.

With regard to steps 1-3, a given system is typically designed for a predefined range of possible working distances (e.g., 0.5-20 meters), and for all respective disparities (i.e., for disparities that can be one-to-one mapped to possible distances). Typically, the distance between the two spatially displaced image sensors dictates the minimal working distance from the stereo vision system (e.g., if the sensors are far apart—then there is no overlapping field of view at short distances).

Some embodiments of the present invention employ deep learning to perform the cross-modality face matching, in which the system uses an algorithm that is trained to learn a good representation of facial features. To this end, the facial matching problem is described herein as an anti-spoofing problem: given a face patch acquired by a first modality and another face patch acquired by a second modality, the system is tasked with classifying whether the two faces match, i.e., whether the features are of the same person and of the same facial posture, or of a different person. (A face patch, which is a particular case, yet common case, of an image patch, typically comprises a rectangular region of an image, cropped by a head detection algorithm.)

The problem of cross-modality image patch matching is ill-defined since the appearances of different objects can be similar in one modality while highly different in another. Since the goal is the registration of facial features, the disclosed techniques mitigate this difficulty by focusing on a specific case of facial feature matching in training a neural network to find the disparity between a LWIR image patch and a NIR image patch, or vice versa.

A neural network is thus trained to correctly choose “patch-over-patch” as the correct matched face patch. To this end, during training, true and false region-of-interest search patches are compared against a query patch. The technique includes constructing a cross-modality anti-spoofing artificial neural network (ANN) that has two fully-convolutional “pipes,” each of which trained on a single modality (for example, LWIR modality and NIR modality). In some embodiments, one of the pipes is split into a Siamese pair of sub neural networks, with the Siamese pair used for training the ANN to perform anti-spoofing using one sub-pipe inputted with ground truth image patches, and the second pipe inputted with spoofed image patches. The spoofing face for this training is either chosen from a different subject or the same subject with a different facial posture. To achieve a robust classification, various augmentations, such as slight rotations, skewing, scaling, and noise, are applied to inputs of the Siamese sub-neural network pair to the corresponding face.

Once training is complete, the ANN weights are used for inference with one input being the acquired LWIR image patch and the other being a search image patch in NIR. The ANN determines to what degree (between zero and one) a patch of the search image that includes a face (i.e., a face patch) matches the query image patch.

One embodiment of the present invention provides a system comprising a dual-wavelength (e.g., LWIR and NIR) stereo vision camera, a memory, and a processor. The memory of the system is configured to store weights of an ANN trained to estimate a spatial disparity between the first image patch and the second image patch after image patches are rectified. The processor of the system is configured to (a) rectify the first and second images, (b) apply the trained ANN to a first image patch of the first image and a second image patch of the second image in order to estimate registration of the first and second image patches, and to estimate a degree of matching of the two image patches at the estimated registration, and (c) output the estimated degree of matching for use by either an anti-spoofing algorithm, or a human activity monitoring algorithm, such as respiration monitoring and/or human core body temperature analysis.

In an embodiment, the human activity monitoring algorithm is a medical indication of activity, such as breathing quality during sleep.

In another embodiment, a system is provided that comprises a stereo vision camera comprising a first imaging device configured to acquire a first image patch of an object (e.g., a human face) at a first wavelength range (e.g., NIR) from a first direction, a second imaging device configured to acquire a second image patch of the object at the first wavelength range from a second direction, and a third imaging device configured to acquire a third image patch of the object at a second wavelength range (e.g., LWIR) from a third direction. A processor of the system is configured to (a) estimate a disparity between a first image patch of the first image and a second image patch of the second image, (b) using the estimated disparity, estimate a degree of matching of a third image patch of the third image and one of the first and second image patches, and (c) output the estimated degree of matching for use by either an anti-spoofing algorithm or a human activity monitoring algorithm.

The disclosed solution is able to differentiate between people, thus allowing it to perform well in crowded scenes. As expected, while the algorithm may match different LWIR head patches and NIR head patches, the matching yields a higher confidence rate on the true ROI, while only a lower confidence rate is received with a false match. Thus, for example, thresholding a confidence level may be used to classify a scanned head patch as true or false match.

The disclosed approach uses a cross-modality face anti-spoofing mechanism for cross-imaging-modality matching. By applying an anti-spoofing-based matching between the modalities, not only are the disclosed techniques able to successfully and accurately match and compute the disparity of a given face, but are also able to work remarkably well in crowded scenes by avoiding incorrect face matching.

### System Description

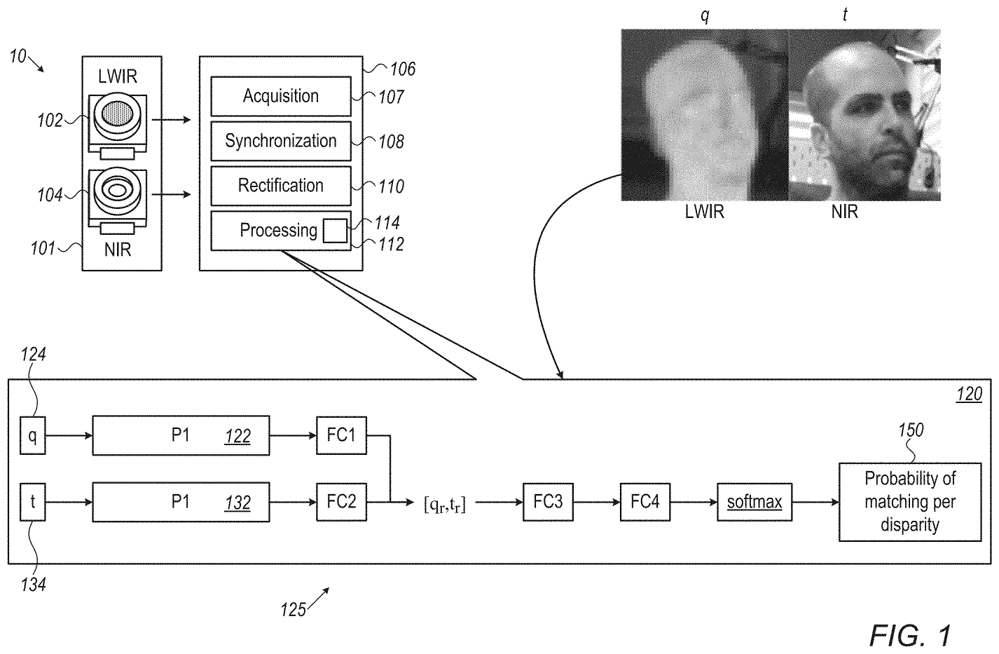

FIG. 1 is a schematic, pictorial block diagram of a dual-wavelength imaging system 10 configured to perform image patch registration of an acquired face using a trained artificial neural network (ANN) 125, in accordance with an embodiment of the present invention. The image patch registration is facilitated by performing cross-modality anti-spoofing, as described below.

System 10 comprises a processor 106 and two image sensors (102, 104) of different wavelength ranges. The two image sensors are arranged in a stereo vision layout 101. The processor handles the acquisition (107), synchronization (108) and rectification (110) followed by NN processing steps 112 (e.g., image patch registration) and storage in a memory 114 of the image patch for subsequent use in various monitoring applications.

In the shown embodiment, image sensor 102 operates at long-wave infrared (LWIR) wavelengths defined above (such as a microbolometer array with sensitivity to wavelengths around 10 μm), and image sensor 104 which operates in the near infrared (NIR) range defined above (such as a CMOS sensor, with peak sensitivity at wavelengths around 1 μm). These wavelength ranges, however, are given by way of example. In alternative embodiments, any other suitable wavelength ranges can be used, such as short-wave IR or medium-wave IR, and UV (e.g., for industrial applications).

System 10 calibration is accomplished by tracking a known pattern (not shown) in both modalities. For example, to calibrate a LWIR-NIR system, a black and white checkerboard is constructed with an identical thermal signature by attaching heating elements behind the black squares. Once the tracking is accomplished, multiple images of different positionings of the tracked pattern are recorded.

To synchronize the two modalities, a delay is applied to one of the modalities such that the frames in which the pattern is located at extremes of the field of view (e.g. furthest to the right, furthest to the top, etc.) are in agreement between the two modalities. Since the calibration pattern used is of known dimensions, calibration coefficients are derived by solving for the sensors' intrinsic parameters (focal length, principle point and sensor format) and extrinsic parameters (translation and rotation between the two sensors) using geometrical methods.

ANN 125 architecture involves two fully-convolutional “pipes,” p₁ and p₂. Each of these pipes is trained on a single modality (for example, p₁ using LWIR image patches and p₂ using NIR image patches). Without loss of generality, let p₁ be the query pipe inputted with a LWIR query image patch 124, q, the image patch obtained from a head detection algorithm ran beforehand, and p₂ the search pipe inputted with a NIR search image patch 134, t. The query pipe processes result in a latent representation of the query patch (e.g., an image of a face in a crowd) that can be matched with the latent representation of the ROI outputted from the search pipe processing. The purpose of the ANN 125 pipes is to produce a common latent representation for cross-modality comparison.

To this end, each pipe of ANN 125 comprises convolutional layers (122, 132) and fully connected layers (FC1-FC4), as would occur to a person skilled in the art. By way of example, each pipe is constructed from several consecutive ReLU activated convolutional layers. All of the layers utilize a 3×3 kernel with a varying number of kernels per layer. Alternatively, other sizes and arrangements of layers and kernels may be used.

Outputs 150 of ANN 125 include (i) a most likely registration of query and search image patches, q and t, achieved by analyzing a probability distribution of all possible disparities between the query and search image patches that ANN 125 generates (e.g., finding a disparity yielding minimal matching loss of the SoftMax function), and (ii) a confidence level (e.g., probability value) at the most likely registration, that that query and search images match.

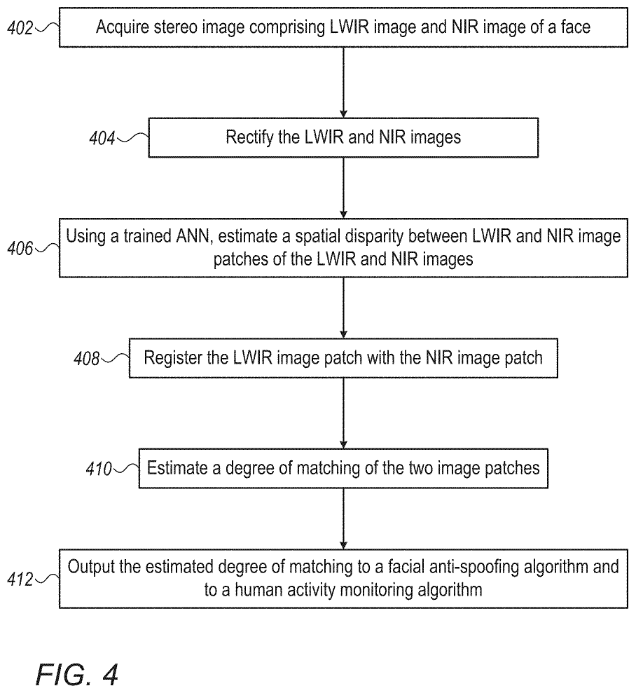

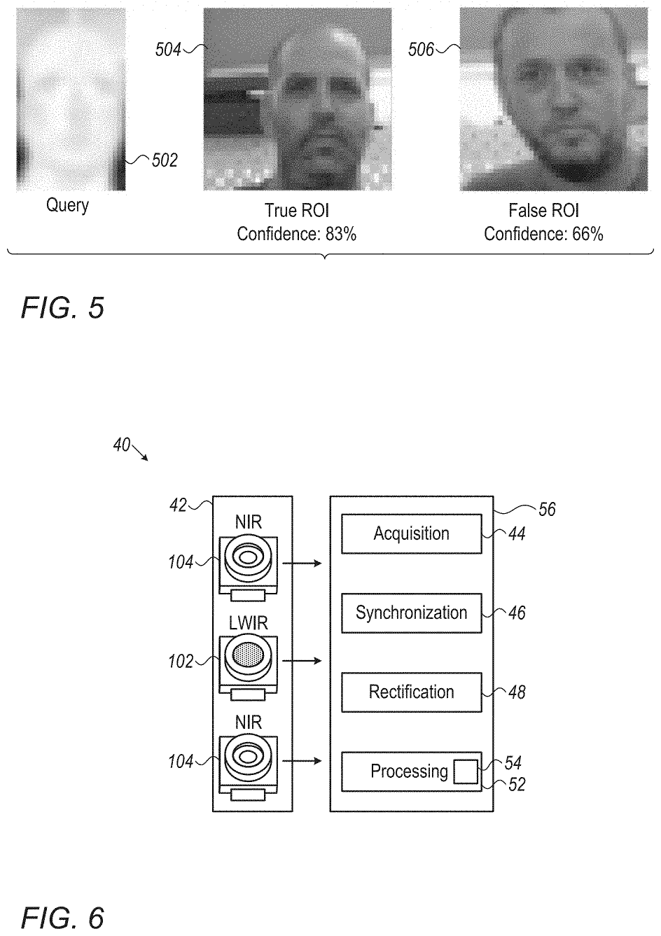

The training of ANN 125 is described in FIG. 3, using an ANN 135, and the subsequent use for inference of a search image to obtain outputs (i) and (ii) is described in FIGS. 4 and 5.

Some preprocessing steps of system 10 are described below for clarity of presentation.

### Rectification

As seen, image patches q and t in FIG. 1 are already shown rectified (by processor 106). During runtime, system 10 matches a feature in one modality with the same feature in the other modality. Based on epipolar geometry, a pixel found in one modality will be located along the epipolar line of the other. To allow for efficient search along that line, and given the grid-like structure of image patches, it is best that the line be either horizontal (along a row of pixels) or vertical (along a column of pixels). This is achieved if sensors 102 and 104 are assembled such that they are co-planar either completely horizontally or vertically. Since it is difficult to assemble a system that is precisely co-planar, a geometrical transformation (rectification) is applied to the images so that the transformed image planes are horizontally co-planar.

In doing so, it is guaranteed that each feature in one modality appears on the same horizontal line in the other.

### Inferring Disparity

Assuming a horizontal rectification, the distance in pixels between the location of a feature in one modality, (x, y), to the other, (x′, y′), is referred to as the disparity, d=x′−x.

Disregarding edge cases, given a feature and its corresponding rectified row in one modality, it can assume that its matching feature is located somewhere along the same row in the other modality. Thus, a probability can be calculated of each location being the correct location with the probability of all such locations summing to 1. Unfortunately, inferring the probability distribution of the disparities is a difficult task because features in one modality may appear completely different than those in another modality (e.g., when using NIR and LWIR).

Furthermore, the problem of cross-modality matching is ill-defined since the appearances of different objects can be similar in one modality while highly different in another. However, this difficulty in registering facial features using the disclosed technique is solved by focusing on the specific case of facial feature matching in training ANN 125 to find the disparity between a pair of LWIR and NIR image patches.

As the images are horizontally rectified, as explained above, it is guaranteed that a pair of corresponding pixels in the NIR and LWIR images lie on the same row. Thus, the problem can be defined as one of detecting the disparity of a given query patch as a classification problem.

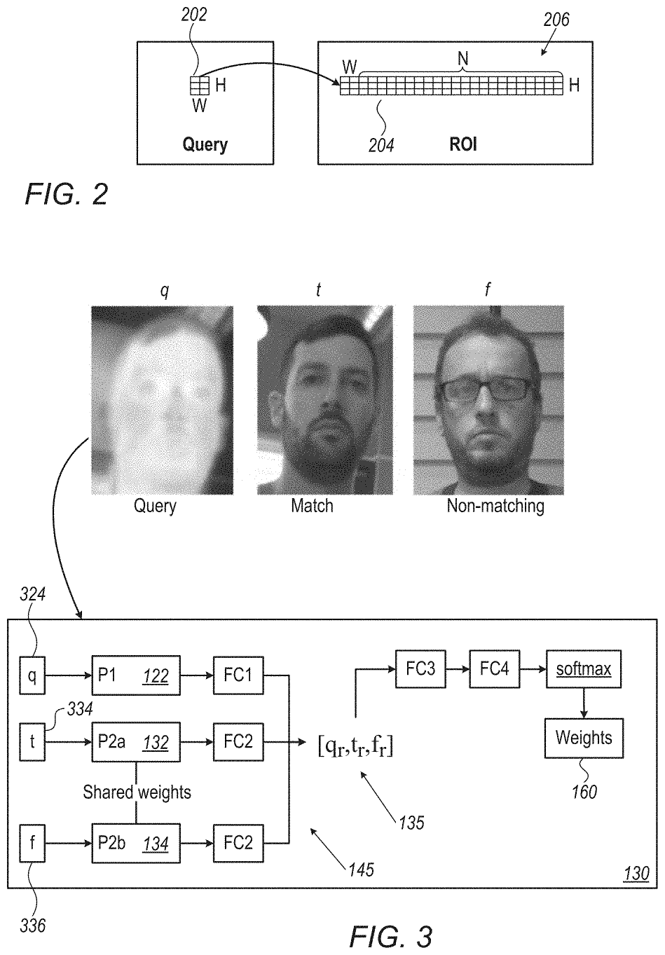

FIG. 2 is a diagram that schematically illustrates handling of a task of estimating a disparity of a given query patch 202 as a classification problem that can be solved using ANN 125 of FIG. 1, in accordance with an embodiment of the present invention.

In the shown embodiment, query patch 202 is a thermal image patch of a full face, such as image patch 124, q, shown in FIG. 1.

Let N be the maximal disparity, i.e. the maximal displacement of the feature along the x coordinate. Thus, the query patch in one image is matched to an ROI patch 204 in the NIR image (e.g., a NIR image containing image patch 134, t) of size H×(N+W) where H and W are the height and width, respectively, of the query patch, q. We define each disparity location as a distinct class, totaling N different classes 206. Since the probabilities of the disparity locations are not independent of each other, the probability distribution of the disparity is modeled, using a training set of images, as a gaussian distribution centered at the ground-truth disparity label.

Furthermore, since one goal of an embodiment of the invention is cross-modality face matching, rather than general patch matching, system 10 is trained to learn a good representation of facial features. To this end, the problem is modeled as an anti-spoofing problem, as follows. Given a face patch in one modality and another face patch in a second modality, the system is tasked with classifying whether the two faces match, i.e., whether the features are of the same person and of the same facial posture or of a different person, as shown in FIG. 5.

### Training ANN for Dual-Wavelength Face Registration and Anti-Spoofing

FIG. 3 is a schematic, pictorial block diagram of an ANN 135 trained to perform anti-spoofing of facial image patches acquired using system 10 of FIG. 1, in accordance with an embodiment of the present invention.

As seen in block 130, to train cross-modality anti-spoofing neural network 135, ANN 135 is built of a pipe p₁ and of a Siamese pair 145 (having shared weights) of pipe p₂ denoted as p₂ₐ and p_{2b}, with a convolutional layer 134 of pipe p_{2b} being identical to layer 132.

ANN 125 is derived from ANN 135 by (a) dropping pipe p_{2b} of the Siamese pair sub-ANN 145 pipes p₂ₐ and p_{2b}, since pipe p_{2b} is used only when training the model with a spoofed (e.g., false) input 136 to recognize spoofing attempts during inference, and (b) using the weights 160 of ANN 135 generated by the training.

Note that the use of a Siamese pair paradigm is possible here since the input to each of pipes p₂ₐ and p_{2b} belongs to the same modality (e.g., NIR image patches 334, t, and 336, f).

The input to the network for purposes of training is thus a query head LWIR image patch, q, 324, and its corresponding NIR face image patch, t, 334 and a spoofing NIR face image patch, f, 336. To achieve a robust solution, various augmentations are applied to the corresponding face, t, such as slight rotations, skewing, scaling, and noise. The spoofing face is either chosen from a different subject or of the same subject with a different facial posture. The goal is to train ANN 135 to correctly choose patch t over patch f as the correct matched face patch.

### Cross-Modality Face Registration and Anti-Spoofing Using an ANN

FIG. 4 is a flow chart that schematically illustrates a method to perform anti-spoofing of facial image patches acquired using the ANN of dual-wavelength imaging system 10 of FIG. 1, in accordance with an embodiment of the present invention. The algorithm, according to the presented embodiment, carries out a process that begins with system 10 acquiring a stereo image comprising an LWIR image patch and a NIR image patch of a face, such as image patches q and t of FIG. 1, at a dual-modality image acquisition step 402.

Next, processor 106 of system 10 rectifies the acquired images, at an image rectification step 404.

At a disparity inference step 406, processor 106 runs ANN 125 to estimate a spatial disparity between image patches q and t.

Processor 106 registers image patch q with image patch t, at an image registration step 408. The registration may be performed, given a predefined range of possible working distances, for all disparities (i.e., disparities that can be one-to-one mapped to possible distances) to produce a distribution, or only between patches of the most likely disparity.

Next, processor 106 estimates a degree of matching of registered image patches q and t, at an image matching estimation step 410.

Finally, at an outputting step 412, system 10 outputs the estimated degree of matching for use with a facial anti-spoofing algorithm, and for use with a human activity monitoring application, such as medical condition monitoring of an identified hospital patient.

### Anti-Spoofing Performance

FIG. 5 is diagram showing an actual performance of the dual-wavelength imaging system FIG. 1 in differentiating between acquired faces, in accordance with an embodiment of the present invention. The example shows how system 10 is able to differentiate between people, thus allowing it to perform well in crowded scenes.

In the example, a query image patch 502 is compared against a true (504) and false (506) region-of-interest (ROI) of a respective NIR image. As expected, while the algorithm successfully matches a LWIR head and a NIR head, the matching results in a confidence rate of 83% on the true ROI 504, while a confidence rate of only 66% is achieved with the false match (patch 506). Note that, since by definition, the ROI always contains the sought-after match, the resulting probability of all possible disparities sums to 100%. The confidence rate and disparity probability mean the same herein. To this end, typically, a library function, such a SoftMax normalization is applied on the resulting “probability” values: to achieve a total probability of 1.

### Alternative Embodiment of the Dual-Wavelength Imaging System

FIG. 6 is a schematic, pictorial block diagram of a dual-wavelength imaging system 40 configured to perform anti-spoofing of an acquired facial image patch, in accordance with another embodiment of the present invention.

System 40 is constructed from two NIR image sensors 104 that are arranged in a stereo vision layout 42 with a LWIR sensor 102 between them. System 40 further includes a processor 56 that handles the acquisition (44), synchronization (46) and rectification (48) followed by processing steps (52) and storage in a memory 54 of the images for subsequent use in various monitoring applications.

System 40 calibration and synchronization are similar to that of system 10.

In system 40 disparity is estimated from sensors 102 using geometrical methods. For example, the disparity can be can found via a known passive stereo matching between the two NIR sensors. Given the disparity, the distance to the object can be estimated. Alternatively, given the distance, the system can compute the disparity between either NIR sensor and the LWIR sensor (using known intrinsic & extrinsic parameters of all the sensors).

Processor 56 then estimates a degree of matching of the LWIR image patch to one of the NIR images, given the known disparity. Processor 106 then outputs the estimated degree of matching for use by either an anti-spoofing algorithm or a human activity monitoring algorithm.

The different elements of ANNs 125 and 135 of FIGS. 1 and 3, respectively, and of processor 106, may be implemented using suitable hardware, such as in one or more Application-Specific Integrated Circuits (ASICs) or Field-Programmable Gate Arrays (FPGAs), using software, using hardware, or using a combination of hardware and software elements. The same holds for elements of processor 56 of FIG. 6.

In some embodiments, some or all of the functions of ANNs 125 and 135, e.g., some or all of the functions of processor 106, may be implemented in a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory. The same holds for elements of processor 56 of FIG. 6.

The disclosed systems 10 and 40, which are described hereinabove, are brought by way of example, purely for the sake of conceptual clarity. Any other suitable system can be used in alternative embodiments, such as using other wavelengths.

Although the embodiments described herein mainly address visual surveillance and monitoring of human activity, the methods described herein can also be used in other applications, such as in industrial applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a stereo vision camera comprising a first imaging device configured to acquire a first image of an object in a first wavelength range from a first direction, and a second imaging device configured to acquire a second image of the object at a second wavelength range from a second direction;
a memory, which is configured to store weights of an artificial neural network (ANN) trained to estimate a spatial disparity between a first image patch of the first image and a second image patch of the second image; and
a processor, which is configured to:
apply the trained ANN to the first and second image patches so as to estimate (i) the spatial disparity between the first and second image patches, and (ii) a degree of matching between the first and second image patches at the estimated spatial disparity; and
output the estimated degree of matching.

2. The system according to claim 1, wherein the object is a human face.

3. The system according to claim 1, wherein the processor is configured to estimate the degree of matching between the first and second image patches by applying an anti-spoofing algorithm to the first and second images.

4. The system according to claim 1, wherein one of the first wavelength range and the second wavelength range is long-wave infrared (LWIR), and the other of the first wavelength range and the second wavelength range is near infrared (NIR).

5. The system according to claim 1, wherein the processor is configured to rectify the first and second image patches before estimating the spatial disparity.

6. The system according to claim 1, wherein the processor is configured to derive the weights of the ANN by training another ANN, which comprises the ANN, wherein the other ANN comprises a Siamese twin sub-neural network.

7. The system according to claim 1, wherein the processor is configured to estimate the spatial disparity by estimating, using the ANN, a probability distribution of the spatial disparity as a function of the spatial disparity between the first and second image patches, and finding the spatial disparity that maximizes the probability distribution.

8. The system according to claim 1, wherein the processor is configured to estimate the degree of matching by normalizing the probability distribution and calculating a value of the normalized probability distribution at the found spatial disparity.

9. A system, comprising:
a first imaging device configured to acquire a first image of an object at a first wavelength range from a first direction;
a second imaging device configured to acquire a second image of the object at the first wavelength range from a second direction;
a third imaging device configured to acquire a third image of the object at the second wavelength range from a third direction; and
a processor, which is configured to:
estimate a spatial disparity between a first image patch of the first image and a second image patch of the second image;
using the estimated spatial disparity, estimate a degree of matching between a third image patch of the third image and one of the first and second image patches; and
output the estimated degree of matching.

10. The system according to claim 9, wherein the processor is configured to estimate the degree of matching between the third image patch and one of the first and second image patches by applying an anti-spoofing algorithm to the third image and one of the first and second images.

11. The system according to claim 9, wherein the processor is configured to estimate the spatial disparity using a geometrical model.

12. The system according to claim 9, wherein the third direction is one of the first direction and the second direction.

13. The system according to claim 9, wherein the third direction is an average of the first direction and the second direction.

14. The system according to claim 9, wherein one of the first wavelength range and the second wavelength range is near infrared (NIR), and the other of the first wavelength range and the second wavelength range is long-wave infrared (LWIR).

15. The system according to claim 9, wherein the processor is configured to rectify the first, second and third images before estimating the disparity.

16. A method, comprising:
acquiring a first image of an object at a first wavelength range from a first direction, and a second image of the object at a second wavelength range from a second direction;
storing weights of an artificial neural network (ANN) trained to estimate a spatial disparity between a first image patch of the first image and a second image patch of the second image;
applying the trained ANN to the first and second image patches so as to estimate (i) the spatial disparity between the first and second image patches, and (ii) a degree of matching between the first and second image patches at the estimated spatial disparity; and
outputting the estimated degree of matching.

17. The method according to claim 16, wherein the object is a human face.

18. The method according to claim 16, wherein estimating the degree of matching between the first and second image patches comprises applying an anti-spoofing algorithm to the first and second images.

19. The method according to claim 16, wherein one of the first wavelength range and the second wavelength range is long-wave infrared (LWIR), and the other of the first wavelength range and the second wavelength range is near infrared (NIR).

20. The method according to claim 16, wherein acquiring the first and second images comprises rectifying the first and second images before estimating the spatial disparity.

21. The method according to claim 16, wherein storing the weights comprises deriving the weights of the ANN by training another ANN, which comprises the ANN, wherein the other ANN comprises a Siamese twin sub-neural network.

22. The method according to claim 16, wherein estimating the spatial disparity comprises estimating, using the ANN, a probability distribution of the spatial disparity as a function of the spatial disparity between the first and second image patches, and finding the spatial disparity that maximizes the probability distribution.

23. The method according to claim 16, wherein estimating the degree of matching comprises normalizing the probability distribution and calculating a value of the normalized probability distribution at the found spatial disparity.

24. A method, comprising:
acquiring a first image patch of an object at a first wavelength range from a first direction;
acquiring a second image patch of the object at the first wavelength range from a second direction;
acquiring a third image patch of the object at the second wavelength range from a third direction;
estimating a spatial disparity between a first image patch of the first image and a second image patch of the second image;
using the estimated spatial disparity, estimating a degree of matching between a third image patch of the third image and one of the first and second image patches; and
outputting the estimated degree of matching.

25. The method according to claim 24, wherein estimating the degree of matching between the third image patch and one of the first and second image patches comprises applying an anti-spoofing algorithm to the third image patch and one of the first and second image patches.

26. The method according to claim 24, wherein estimating the spatial disparity comprises estimating the spatial disparity using a geometrical model.

27. The method according to claim 24, wherein the third direction is one of the first direction and the second direction.

28. The method according to claim 24, wherein the third direction is an average of the first direction and the second direction.

29. The method according to claim 24, wherein one of the first wavelength range and the second wavelength range is near infrared (NIR), and the other of the first wavelength range and the second wavelength range is long-wave infrared (LWIR).

30. The method according to claim 24, wherein acquiring the first, second and third images comprises rectifying the first, second and third images before estimating the disparity.
